(19) United States
(12) Patent Application Publication
(10) Pub. No.: US 2009/0152052 A1
(43) Pub. Date: Jun. 18, 2009

(54) METHOD FOR OPERATING AN INDUSTRIAL TRUCK

(75) Inventor: Carsten SCHOETTKE, Moosburg (DE)

Correspondence Address: ROTHWELL, FIGG, ERNST & MANBECK, P.C., 1425 K STREET, N.W., SUITE 800, WASHINGTON, DC, 20005, US

(73) Assignee: Jungheinrich Aktiengesellschaft, Hamburg (DE)

(21) Appl. No.: 12/334,638

(22) Filed: Dec. 15, 2008

(30) Foreign Application Priority Data
Dec. 14, 2007 (DE) 10 2007 060 433.7
Apr. 30, 2008 (DE) 20 2008 005 966.6

(51) Int. Cl. B66F 17/00

(52) U.S. Cl. 187/223

(57) ABSTRACT

The invention relates to a method for operating an industrial truck (10) with at least one brakable driving wheel (22), a permissible maximum speed of the industrial truck (10) being determined as a function of a picked-up load (24, 24′). The invention proposes that the maximum speed is established depending on a distance (A) which is measured between a first component (34) and a second component (36) of the industrial truck (10) and changes depending on the wheel contact force acting on the brakable driving wheel (22), the two components (34, 36) moving relative to one another as a function of the picked-up load (24, 24′). In addition, the invention relates to an industrial truck with a central control unit for implementing the method according to the invention.

The present invention relates to a method for operating an industrial truck with at least one brakable driving wheel, a permissible maximum speed of the industrial truck (10) being determined as a function of a picked-up load.

In industrial trucks, the wheel contact forces and generally also the weight distribution change depending on the loading state. In the case of order pickers as an embodiment of industrial trucks with a brakable driving wheel and two unbraked wheels, the axle load acting on the brakable and steerable driving wheel is generally reduced by the loading of the vehicle. As a result, the maximum achievable braking effect on this driving wheel or this axle is reduced. The braking distance can be influenced by varying the braking torque or the speed; further influencing variables are the direction of travel and the lifting height. Increasing the braking torque is only sensible, however, up to the point from which the braked wheel is blocked. Since the braking distance is also dependent on the speed and the direction from which the braking is intended to be performed, a restriction of the speed can be taken into consideration, with a general reduction in the speed having a negative effect on the loading and unloading performance of the industrial truck.

A method forming the generic type is known, for example, from EP 0 814 051 B1. In this case, a control signal for the maximum speed is changed depending on the direction of travel and depending on the mass of the picked-up load in such a way that a higher maximum speed is permitted during travel in the direction of a brakable axle than during travel in the direction of a non-brakable axle. The maximum achievable braking acceleration, which determines the maximum permissible speed, is in this case calculated as a function of the variables normal force between roadway and brakable axle when the vehicle is at a standstill, coefficient of friction and total mass of the industrial truck including the picked-up load.

EP 0 343 839 B1 has disclosed a further similar method in which a pressure sensor is provided in the hydraulic system for the purpose of determining the mass of the picked-up load, with the result that a corresponding value for the mass can be detected owing to the proportional dependency between the hydraulic pressure and the mass of the load.

However, determining the mass of a picked-up load does not make it possible to precisely determine the wheel contact force acting on the brakable driving wheel since the load is often distributed nonuniformly on a pallet, which leads to considerable changes in the position of the centre of gravity of the industrial truck, in particular in the case of loads which have been raised to a high level. It is therefore necessary to measure the contact forces on the brakable driving wheel as directly as possible.

In this regard, DE 199 19 655 A1 has already proposed that the measurement of wheel loads can take place by means of force pickups which are fitted, with, for example, strain gauges, piezomeasuring devices, thin film sensors being proposed. Said document also proposes that the contact force is measured taking into consideration the spring stiffness of a tyre and the distance between the wheel axle and the floor. However, the problem arises here that the tyre is subject to wear which is very difficult to take into consideration in such a calculation and that unevenness of the floor may be included in the distance measurement, which then results in erroneous distances and therefore in incorrectly calculated contact forces.

The object of the invention is to provide a method for operating an industrial truck in which the wheel contact forces can be established easily and reliably.

In order to achieve this object, the invention proposes that the maximum speed is established depending on a distance which is measured between a first component and a second component of the industrial truck and changes depending on the wheel contact force acting on the brakable driving wheel, the two components moving relative to one another as a function of the picked-up load.

It has been shown that precise values for the effective wheel contact force can be calculated from a distance measured in such a way on the vehicle itself. In addition, it has also been shown that the wheel contact force has a substantially proportional response with respect to the measured distance. Since this distance measurement takes place on the industrial truck itself, it is independent of influences of wear on the tyre of the wheel or on the wheel itself if the latter is produced from plastic. In addition, such a distance measurement, which detects the elastic deformation of the industrial truck under load, takes place in contactless fashion, which is a simplification in comparison with the previously known strain gauges and the like for measurements of elastic deformations.

By way of a development, it is proposed that the second component is a chassis section of the vehicle on which the driving wheel is supported. In this case, it is preferred if that the first component is a frame section of the vehicle which is indirectly connected to the second component, preferably a frame section which is guided around the driving wheel and is provided for fastening a housing cover.

The selection of the two components is significant in so far as the relative movements of said components with respect to one another must have a dimension which can be detected reliably and precisely by a distance sensor. It is also essential that the two components are not subject to uniform deformation when a load is picked up, with the result that the required and measurable distance change results between them.

In order to be able to take into consideration influences from the direction of travel or braking direction, a hysteresis can be determined for the measured distance, said hysteresis being dependent on the direction of travel of the industrial truck as well as on the measurement point. Given a corresponding selection of the measurement point, the distance between the two components is enlarged, for example, if braking takes place in the direction of the brakable driving wheel, and the distance is reduced, for example, given the same load during braking in the direction of the load. These measurable distance changes given the same mass of a picked-up load therefore need to be taken into consideration in order that a different maximum speed is not calculated after braking in the direction of the driving wheel and therefore an enlarged distance if the load is unchanged and the travel is continued. In the event of a different selection of the measurement point, the distance can also have precisely the reverse response in the different braking directions.

The load torque brought about by the picked-up load can be determined as a function of the measured distance and the hysteresis thereof. In addition, it is proposed that the mass of the picked-up load is measured directly, preferably by measurement of the hydraulic pressure. In combination with a pressure sensor in the hydraulic system, the contact forces can be checked in terms of their probability since firstly there is a precise figure for the picked-up load mass and secondly it is possible to take into consideration influences of the positioning of the mass on the wheel contact force as a result of the distance measurement. In addition, the combined use of a pressure sensor and a distance sensor makes it possible to carry out calibration between the distance sensor and the pressure sensor whenever the pressure sensor emits a value of zero, i.e. whenever there is no load picked up and the load pickup means is arranged in a defined position, in particular in its lowermost position. In addition, in the event of a picked-up load, the pressure sensor signal can be used in order to make a decision as to whether the load has changed or whether the change in the distance is hysteresis-related.

In order to make it possible to determine the effective wheel contact force on the driving wheel more precisely, it is proposed that the lifting height of the load is measured. In the event of accelerated movements (acceleration/braking) the wheel contact force changes owing to the effective load torque about the centre of gravity of the industrial truck depending on the lifting height. It is thus possible to match the maximum speed if an identical mass of the picked-up load is subject to accelerations given a different lifting height.

It is furthermore proposed that when establishing the maximum speed, the measured distance with the hysteresis, the wheel contact force derived therefrom on the driving wheel, the mass of the load and the lifting height of the load are taken into consideration. The combination of these measured values established by sensors makes it possible to determine the effective contact force on the brakable driving wheel in a reliable and precise manner, with the result that a corresponding maximum speed can be selected. However, it is not absolutely necessary for all of the values to be used in the calculation. Further information still can also be called up, if appropriate, and taken into consideration, such as the direction of travel, for example.

Since the two components also move relative to one another during travel, for example as a result of unevenness of the ground, it is preferred that the measurement of the distance takes place in a suitable operational state, preferably when the industrial truck is at a standstill. In this case, the measurement can take place in particular a plurality of times in the standstill state in order to also take into consideration the picking-up or setting-down of a load and in order to provide a distance value directly prior to the beginning of travel once the presence of a load and the effective load torque and possibly the mass and lifting height thereof have been established. In order to be able to take the hysteresis influences into consideration more effectively in the distance measurement, the direction of travel from which the braking takes place at a standstill can also be fixed in the standstill state. It is also conceivable for the distance measurements to be carried out given the creep rate of the vehicle or on sections of roadway in which there are no notable relative movements.

In addition, it is proposed that when a specific wheel contact force is undershot, an undershoot signal is generated. This can indicate an impermissible load case if, for example, a mass which is permissible per se and which is distributed nonuniformly on the load pickup fork is subject to an acceleration and is lifted to a height which, owing to the effective load torque, results in a severe reduction in the wheel contact force. To this extent, the distance measurement between the two components can also contribute to increased safety during operation.

In order to carry out the evaluation and in order to steer the industrial truck correspondingly, the measured signals or values are transmitted to a central control unit of the industrial truck, the control unit calculating the maximum speed.

It is additionally proposed that the control unit, in the event of the detection of the undershoot signal, initiates a corresponding operational state of the industrial truck, preferably the standstill state of the industrial truck.

In accordance with another aspect, the invention relates to an industrial truck with a central control unit for implementing the method according to the invention. In this case, the industrial truck comprises at least one brakable driving wheel, a vertically adjustable load pickup means and at least one distance sensor, which is arranged on a first component of the industrial truck in such a way that the distance from a second component can be established, the first and the second component being capable of moving relative to one another as a function of a load picked up on the load pickup means.

The control unit is preferably designed in such a way that it can, by evaluation of the measured distance, establish a wheel contact force acting on the driving wheel and can fix a maximum speed for the industrial truck.

In addition, the industrial truck can have a load sensor, preferably a hydraulic pressure sensor, which establishes the mass of the picked-up load. It is further proposed that it has a lifting height sensor for detecting the lifting height of the load pickup means or of the picked-up load.

In this case, the signals from the load sensor and/or from the lifting height sensor can be transmitted to the control unit and can be taken into consideration by said control unit when establishing the maximum speed.

In accordance with a preferred embodiment, two distance sensors are provided which each detect a distance from the second component. In this case, the two sensors can be arranged on opposite sides of the second component. It is particularly advantageous if the two sensors are arranged diametrically opposite one another, with the second component running between them.

If a linear sensor characteristic is assumed in the arrangement of two sensors, a constant sum of the voltages or distances detected by the two sensors results given such an arrangement. Manipulations and damage can thus be safely detected.

The invention will be described by way of example below using an exemplary embodiment with reference to the attached figures, in which:

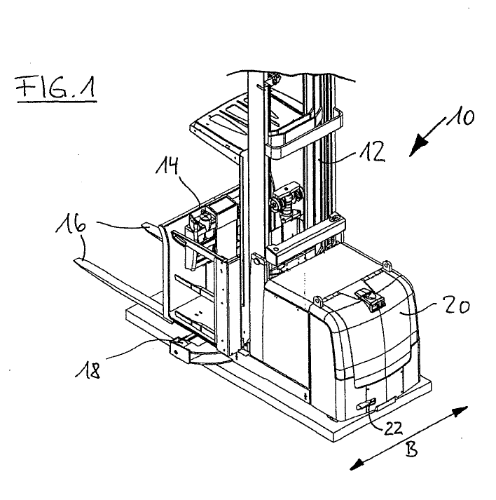

FIG. 1 shows a schematic perspective illustration of an order picker at an angle from the rear.

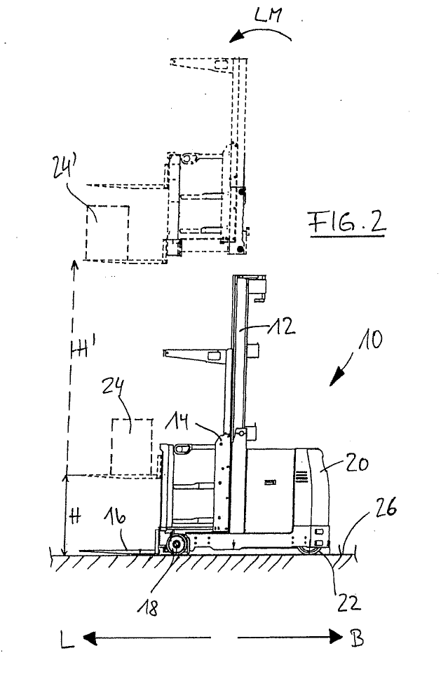

FIG. 2 shows a lateral schematic front-view illustration of the order picker with the driver's cab or load pickup fork in the lowered or raised position.

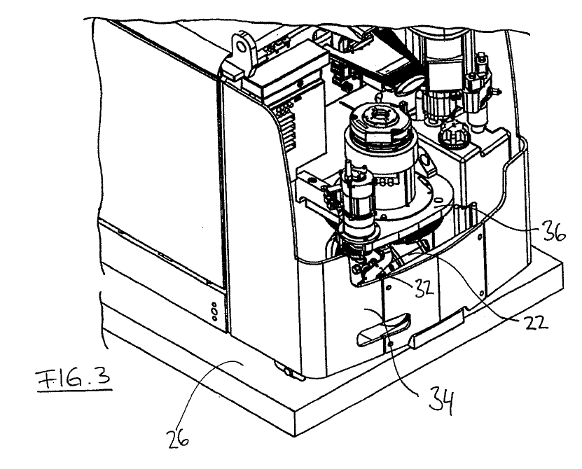

FIG. 3 shows an enlarged perspective view of a rear part of the order picker with the housing cover removed.

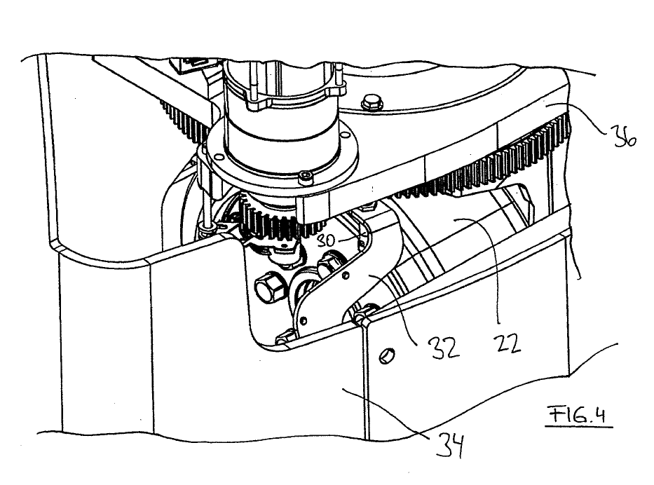

FIG. 4 shows an enlarged perspective view of the arrangement of the distance sensor.

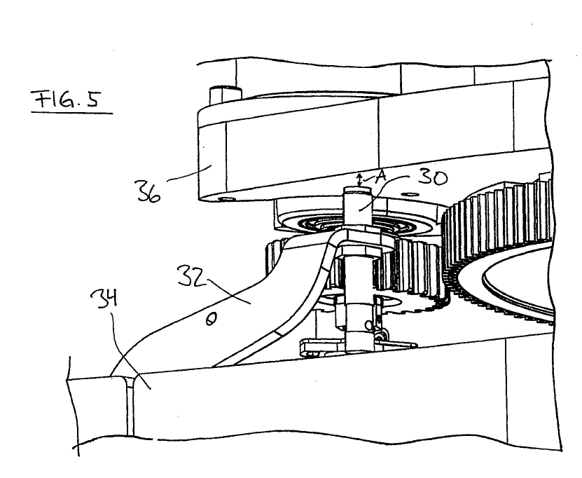

FIG. 5 shows a further perspective illustration of the sensor arrangement.

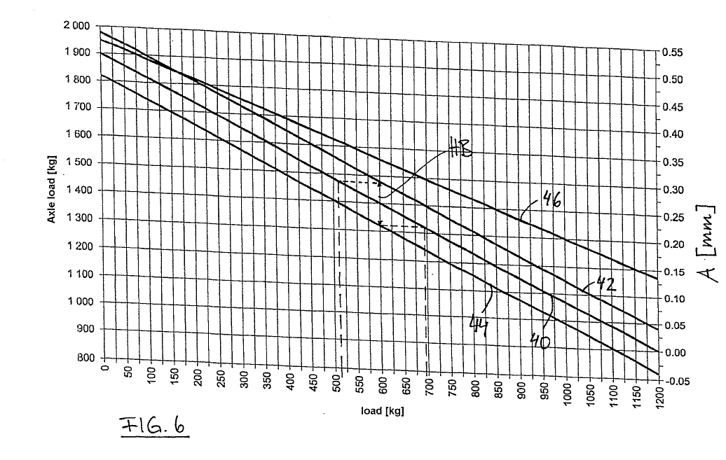

FIG. 6 shows a graph showing the relationship between the axle load, the mass of the picked-up load and the measured distance.

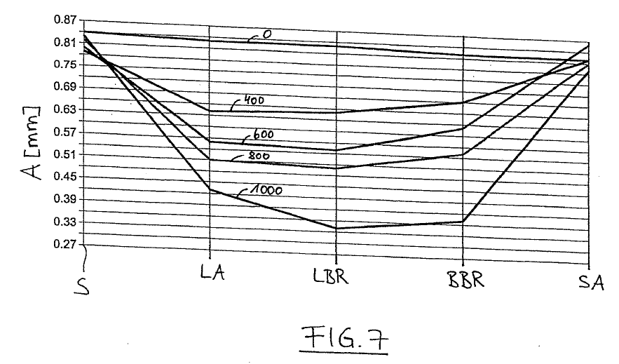

FIG. 7 shows a graph showing the associated distance values for different load masses and different operational states.

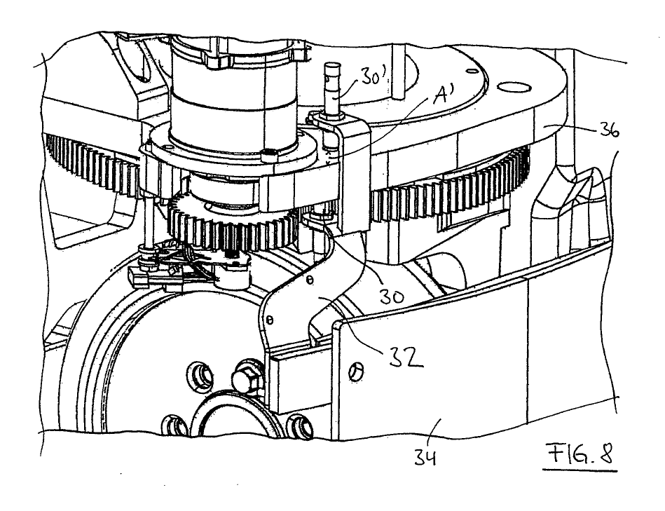

FIG. 8 shows an enlarged perspective view of an embodiment with two distance sensors.

FIG. 1 shows an industrial truck in the form of an order picker 10 at an angle from above. The order picker 10 has a mast 12, which can be extended telescopically in the vertical direction, a driver's cab 14, which can be displaced along the mast 12, and a load pickup means in the form of a load fork 16 fitted on said driver's cab 14. The order picker 10 is a three-wheeled vehicle, having two front wheels or rollers 18, which are neither driven nor braked and of which only the left-hand roller is illustrated. These rollers can naturally also be braked and possibly driven in other embodiments. There is a driven, brakable and steerable wheel 22, which is arranged centrally in relation to the width direction B, in the rear region beneath a cover 20.

As can be seen from the lateral front-view illustration shown in FIG. 2, on the one side the load fork 16 is vertically displaceable relative to the driver's cab 14, and the driver's cab 14 can be displaced along the telescopically movable mast 12 from a lowered position into a position illustrated by dashed lines. If a load 24 has been picked up on the load fork 16, a load torque LM which is constant when the order picker 10 is at a standstill acts with increasing lifting height H, H′. This load torque LM changes as a function of accelerations acting on the order picker 10, with this load torque also being dependent on the position of the load 24, 24′ in the horizontal direction on the load fork 16. If the load 24′ has been picked up in the region of the front ends of the load fork 16, the load torque will be correspondingly greater, and the wheel contact force in the case of the driving wheel 22 is further reduced. It is therefore advantageous that not only the mass of the load 24, 24′ can be determined as precisely as possible, but that also the wheel contact force acting in the case of the driving wheel 22 on the ground 26 can be determined as precisely as possible.

In order to be able to determine the effective wheel contact force, the order picker 10 has at least one distance sensor 30 (illustrated by way of example in FIG. 5), which is fitted on a mount 32 which is bent at an angle. This mount 32, as can be seen in FIGS. 3 and 4, is fitted on a component 34 of the industrial truck 10, which component forms a housing for the driving wheel 22 and on which component the cover 20 (FIG. 1) can be fitted. The mount 32 is shaped in such a way that the distance sensor 30 is arranged substantially vertically beneath a mount plate 36, via which the driving wheel 22 is supported on the chassis of the industrial truck 10. A distance A is provided between the upper side of the sensor 30 and the lower side of the plate 36, and this distance changes when a load 24, 24′ is picked up on the load fork 16 and is detected by the distance sensor 30. The change in the distance A is a result of relative movements between the frame component 34 or the mount 32 and the mount plate 36 if a load 24, 24′ is picked up. In this case, the axle load or wheel contact force acting on the driving wheel 22 decreases as the mass of the picked-up load 24 increases, and at the same time the distance A is reduced as the mass of the picked-up load increases since the frame component 34 comes close to the mount plate 36 by fractions of millimetres in the context of the possible elastic deformation when a load is picked up.

The measurement of the distance A which in principle represents a deformation measurement, has a hysteresis which becomes noticeable in a different direction depending on the direction of travel. On the basis of the graph in FIG. 6, the line 40 shows the profile of the distance A in millimetres (scale on the right-hand side) and the associated lines 42 and 44 fixing the hysteresis. If a load of 600 kg, for example, is picked up and is raised to a specific lifting height, a change in distance of 0.25 mm takes place, with deformations of approximately 0.22-0.28 mm being possible taking into consideration the hysteresis as a function of the direction of travel or braking direction. Using these upper and lower deformation values as a basis, it is demonstrated that a load range of slightly more than 500 kg up to slightly less than 700 kg can be attributed to the distance 0.25 mm, which is represented by dashed lines in the graph in FIG. 6. The lines 42, 44 represented here represent a hysteresis range HB for the distance A, as it needs to be taken into consideration if the direction of travel is not taken into consideration in the calculation. If the direction of travel is taken into consideration, the hysteresis range HB may also be smaller, in particular halved. FIG. 6 also shows the line 46, which shows the profile of the axle load or wheel contact force acting on the driving wheel 22 as a function of the picked-up load. As has already been mentioned, the axle load decreases from slightly below 2000 kg to slightly below 1200 kg given loads of from 0 to 1200 kg. Owing to the profile of the lines 40, 46, it can also be seen that corresponding axle load values can also be assigned to a specific distance value, possibly taking into consideration the hysteresis, with the result that a suitable maximum speed for the industrial truck can be fixed which allows for safe braking of the industrial truck corresponding to the picked-up load.

Other contact forces naturally result in the case of different lifting heights and in the case of accelerated movements (acceleration/braking).

FIG. 7 shows a graph which shows the associated measured distance values for different masses and different operational states. At time S, the industrial truck is at a standstill and no load has been picked up. At time LA, a load was picked up, with the graph illustrating the lines for five different loads of 0 to 1000 kg. The lines have corresponding numbers 0, 400, 600, 800, 1000 in order to represent the mass in kilograms of the picked-up load. It can be seen that, at time LA, the distance A between the two components 34, 36 in all cases of a load being picked up (400 kg and above) markedly decreases and also assumes different values as a function of the picked-up load. From time LA, the industrial truck moves in the direction of the load L (FIG. 2) and, at time LBR, is braked in this direction. It is shown that the distance A changes only insignificantly given the loads 400-800 kg, but is reduced markedly given a load of 1000 kg. From this position, the industrial truck is now moved backwards in the driving direction B (FIG. 2) and is then braked in this direction at time BBR. It is shown in the case of all loads (400, 600, 800 and 1000 kg) that the distance A is greater again owing to the acting load torque LM. At time SA, the picked-up load has again been lowered, and the distance A again increases to a value in the region of the standstill state S. It is apparent from the graph in FIG. 7 that the distance A changes as a function of the direction of travel or braking direction given the same load, as a result of which the hysteresis HB represented in FIG. 6 can be explained.

In addition to the distance sensor 30, the industrial truck can also comprise a pressure sensor (not illustrated), which is accommodated in the hydraulic system and which determines the mass of the picked-up load, with the result that the load range established according to FIG. 6 can be restricted for a distance A in the calculation of the load-dependent maximum speed. The load can of course also be established via different routes, for example chain force via a load cell, strain gauges or the like. In addition, it is preferred that a lifting height sensor (not illustrated) is arranged on the industrial truck in order to determine the present lifting height of the load and in order to be able to likewise take this parameter into consideration in the calculation of the wheel contact force.

During operation, the maximum speed of an unladen industrial truck may be equal (initially) in both directions of travel. When the vehicle is at a standstill, evaluation of the sensors, in particular of the distance sensor, takes place, with said sensor producing a control signal which is dependent, in particular proportionally, on the load torque. The pressure sensor produces a control signal which is dependent, in particular proportionally, on the load. This signal can be used to make a decision from one standstill face to the next as to whether the load has changed or whether the change in the distance A is hysteresis-related. Finally, possibly also using the lifting height, the wheel contact force is established and then the maximum possible speed is determined, possibly also in a directionally dependent manner. A reduction in speed is nevertheless generally only effective in the case of greater loads, which is a very rare load case in order picking trucks, with the result that the proposed method should result in no notable reduction in the loading and unloading performance. In addition, the proposed method makes it possible for the axle load of the braked axle not to need to be designed for the load case “fully laden”. In the example shown, the axle load of the unladen order picker is approximately 1900 kg. When fully laden, an axle load of approximately 900 kg results, which is the minimum necessary in order to safely brake the order picker from full speed. If the 900 kg is undershot, safe braking is only possible given a reduced maximum speed. The proposed method provides the possibility of reducing the axle load in terms of construction to 500 kg, for example, in the fully laden state since the axle load is detected and a corresponding reduction in the maximum speed can be initiated. Such a saving in terms of the axle load has an effect on the raw materials (for example steel, battery) used for the production. The industrial truck therefore does not necessarily need to be equipped with heavy components in order to ensure the required operational safety.

The distance sensor 30 used may be a conventional analogue distance sensor, which is in the form of an inductive proximity sensor with a small measurement range and a high resolution. Such a sensor is particularly suitable for the distance measurement from a metal piece, such as the mount plate 36.

FIG. 8 illustrates an embodiment with two sensors 30, 30′. The two sensors 30, 30′ are fitted on the frame component 34 via the mount 32. One sensor 30 is aligned from below with respect to the mount plate 36, and the other sensor 30′ points towards the upper side of the mount plate 36. The two sensors 30, 30′ are therefore arranged substantially orthogonally with respect to the mount plate 36 and are substantially opposite one another, preferably diametrically opposite one another, with the mount plate 36 being arranged between the two sensors 30, 30′ at a respective distance A, A′. Such a measurement arrangement with two sensors 30, 30′, in which the sensors produce, for example, an analogue voltage signal over the measurement range 0-10 V given a distance change of 0-4 mm, results in a constant sum of the voltages or distances given an imaginary linear sensor characteristic. This makes it possible for faults in the measurement arrangement as a result of manipulation or damage, for example, to be detected safely.

For reasons of completeness, reference is made to the fact that values or signals detected by the abovementioned sensors are transmitted to a central control unit 50 (FIG. 3) of the industrial truck 10, with it being possible for this transmission to either take place using wires or wirelessly. The central control unit processes the signals and divides corresponding control signals for the industrial truck 10 from said signals, with the result that safe operation is ensured. In particular, it is also conceivable that an undershoot signal is generated when a specific wheel contact force is undershot, with the result that it is possible for an impermissible load case to be indicated and, for example, it is possible for a standstill state of the industrial truck to be initiated or maintained.

With the proposed method it is possible for a higher speed to be achieved with an unladen or partially laden industrial truck than was previously conventional. Since the detection of the distance A generally takes place in the standstill state of the industrial truck, influences during travel, for example as a result of unevenness of the ground, are not taken into account, which makes the method simple overall. Owing to the fact that the hysteresis of the measured distance A is taken into consideration, it is possible with the proposed method to measure the relative movement between two components 34, 36 and to determine a reliable distance range, with the result that safe conclusions can be drawn on the effective wheel contact force in order to be able to fix the maximum speed of the industrial truck.

1. Method for operating an industrial truck (10) with at least one brakable driving wheel (22), a permissible maximum speed of the industrial truck (10) being determined as a function of a picked-up load (24, 24′), characterized in that the maximum speed is established depending on a distance (A) which is measured between a first component (34) and a second component (36) of the industrial truck (10) and changes depending on the wheel contact force acting on the brakable driving wheel (22), the two components (34, 36) moving relative to one another as a function of the picked-up load (24, 24′).

2. Method according to claim 1, characterized in that the second component is a chassis section (36) of the industrial truck (10) on which the driving wheel (22) is supported.

3. Method according to claim 1, characterized in that the first component (34) is a frame section of the vehicle (10) which is indirectly connected to the second component (36), preferably a frame section (34) which is guided around the driving wheel (22) and is provided for fastening a housing cover (20).

4. Method according to claim 1, characterized in that a hysteresis (HB) is determined for the measured distance (A), said hysteresis (HB) being dependent on the direction of travel of the industrial truck (10).

5. Method according to claim 4, characterized in that the load torque (LM) brought about by the mass of the picked-up load (24, 24′) is determined as a function of the measured distance (A) and the hysteresis (HB) thereof.

6. Method according to claim 1, characterized in that the mass of the picked-up load (24, 24′) is measured directly, preferably by measurement of the hydraulic pressure.

7. Method according to claim 4, characterized in that the lifting height (H, H′) of the load (24, 24′) is measured.

8. Method according to claim 4, characterized in that, when establishing the maximum speed, the measured distance (A) with the hysteresis (HB), the wheel contact force derived therefrom on the driving wheel (22), the mass of the load (24, 24′) and the lifting height (H, H′) of the load are taken into consideration.

9. Method according to claim 1, characterized in that the measurement of the distance (A) takes place in a suitable operational state, preferably when the industrial truck (10) is at a standstill.

10. Method according to claim 1, characterized in that when a specific wheel contact force is undershot, an undershoot signal is generated.

11. Method according to claim 1, characterized in that measured signals or values are transmitted to a central control unit (50) of the industrial truck, the control unit calculating the maximum speed.

12. Method according to claim 10, characterized in that the control unit (50), in the event of the detection of the undershoot signal, initiates a corresponding operational state of the industrial truck, preferably the standstill state of the industrial truck.

13. Industrial truck with a central control unit (50) for implementing the method according to claim 1, comprising at least one brakable driving wheel (22), a vertically adjustable load pickup means (16) and at least one distance sensor (30), which is arranged on a first component (34) of the industrial truck (10) in such a way that the distance (A) from a second component (36) can be established, the first and the second component (34, 36) being capable of moving relative to one another as a function of a load (24, 24′) picked up on the load pickup means (16).

14. Industrial truck according to claim 13, characterized in that the control unit is designed in such a way that it can, by evaluation of the measured distance (A), establish a wheel contact force acting on the driving wheel (22) and can fix a maximum speed for the industrial truck (10).

15. Industrial truck according to claim 14, characterized by a load sensor, preferably a hydraulic pressure sensor, which establishes the mass of the picked-up load.

16. Industrial truck according to claim 14, characterized by a lifting height sensor for detecting the lifting height of the load pickup means or of the picked-up load.

17. Industrial truck according to claim 15, characterized in that the signals from the load sensor and/or from the lifting height sensor can be transmitted to the control unit and can be taken into consideration by said control unit when establishing the maximum speed.

18. Industrial truck according to claim 13, characterized in that two distance sensors (30, 30′) are provided which detect the respective distance (A, A′) from the second component (36).

19. Industrial truck according to claim 18, characterized in that the two sensors (30, 30′) are arranged on opposite sides of the second component (36), preferably diametrically opposite one another.
